(19) United States
(12) Patent Application Publication
(10) Pub. No.: US 2011/0108409 A1
(43) Pub. Date: May 12, 2011

(54) USE OF SUPERHEATED STEAM DRYERS IN AN ALCOHOL DISTILLATION PLANT

(76) Inventor: Christopher J. Brown, Amherst, NY (US)

(21) Appl. No.: 13/002,509

(22) PCT Filed: Jul. 7, 2009
(86) PCT No.: PCT/US09/49769

§ 371 Date: Jan. 4, 2011

Related U.S. Application Data
(60) Provisional application No. 61/078,479, filed on Jul. 7, 2008.

(51) Int. Cl. B01D 3/02

(52) U.S. Cl. 203/42; 202/153; 202/154; 203/49

(57) ABSTRACT

The present invention is for the production of fuel grade alcohol, specifically ethanol. A steam dryer is used to dry the solid byproduct into usable animal feed. The steam dryer typically contains less than 6% air in its exhaust stream is directed to the bottoms of one or more distillation columns to heat the distillation column and scrub the exhaust stream simultaneously. The elimination of a thermal oxidizer and the efficient use of the energy in the exhaust stream provide considerable cost savings for an alcohol production plant.

### CROSS REFERENCE TO RELATED APPLICATIONS

This invention claims the benefit of U.S. Provisional Application 61/078,479 filed Jul. 7, 2008, which is incorporated by reference herein in its entirety.

### FIELD OF THE INVENTION

This invention relates to the efficient production of high purity alcohol, particularly fuel grade alcohol.

### BACKGROUND

Ethanol production presents four challenges that must be met in order to economically produce ethanol useful as a fuel additive. First, there must be an effective system so that primary stripping of ethanol/water from stillage (beer) can be accomplished and energy effective rectification of the ethanol/water mixture can be made. Second, an effective system for dehydrating the rectified ethanol/water product must be developed that integrates with the product distillation system and also is integrated in the energy management of that system. Third, an energy efficient system of de-watering and drying the stillage must also be integrated into the overall system. Forth, the propensity for the stillage to foul surfaces in distillation and evaporation must be controlled to limit the time and expense of cleaning the system. Additionally, there is a need to limit energy usage in the dryer which is part of the system to recover dried distillers grains and thermal oxidizer which is part of the plant's emissions control.

Diminishing world supplies and availability of crude oil as well as sporadic regional shortfalls of gasoline for motor fuel have created considerable incentive for the development and use of alternative fuels. Furthermore, environmental concerns have required use of additives which aid in oxygenation of the motor fuels. These additives have created concerns of their own for environmental damage. Ethanol is gaining wide popularity as a fuel additive capable of addressing these concerns, particularly when mixed with gasoline to form a mixture known as gasohol. Gasohol may contain up to about 10 vol. % ethanol, without modifications to presently used automobile engines being required, thereby extending the volume of motor fuel availability by a like percentage.

The source of the ethanol used in gasohol is derived primarily from the fermentation of mash, usually from corn or wheat or other grain. Natural fermentation is able to produce an ethanol-water product mixture containing, at the most, about 12 to 15 vol. % ethanol. This mixture may easily be concentrated by distillation to about 95 vol. % ethanol. Higher concentrations of ethanol, however, as required in gasohol are obtained only by expenditures of great amounts of energy and great difficulty due to the formation of an ethanol-water azeotrope at about the 95% ethanol concentration. A means of achieving the greater than 95% ethanol concentration without 1) such a great expenditure of energy or 2) loss of the used energy would thus be extremely valuable. Such schemes have been employed in the past to recover heat from azeotropic distillation employing tertiary entrainers such as benzene (U.S. Pat. Nos. 4,372,822, 4,422,903 and 5,035,776). Others earlier had considered the option of using heat from the stripping/rectifying column to heat an azeotropic distillation (U.S. Pat. Nos. 1,860,554 and 4,217,178). Additionally, one invention considered generating steam from the heat in overhead vapors of the azeotropic distillation (U.S. Pat. No. 4,161,429) and another used mechanical vapor recompression of the overhead vapors to recover heat in the fashion of a heat pump for heating the azeotropic distillation column(s) (U.S. Pat. No. 5,294,304). U.S Publication No. 2007/0000769 discloses an ethanol distillation with distillers soluble solids recovery apparatus. Dehydration of ethanol to dryness typically of 0.5 wt % water has been accomplished in most plants constructed for the past 15 to 20 years by pressure vacuum swing adsorption using 3A Zeolite.

Another problem presented in the production of ethanol is the removal of solids from the production stream. In the production of fuel alcohol from plant materials, the biomass is mixed with hot water to produce a wort (brewery terminology or typically called “mash” in distilleries and fuel ethanol plants), which is fermented until the final alcohol level is reached. The fermented contents are then typically discharged as a slurry to the beer well and from there to the beer still where the alcohol is removed by distillation. The remainder, after distillation, is known as the still bottoms or stillage, and consists of a large amount of water together with the spent solids.

Stillage in general has a complex composition, which in the case of corn feed stocks, includes the non-fermented fibers from the hull and tipcap of the corn kernel, as well as, particles of the corn germ with high oil content, oil and other lipids, the non-fermented portions of the corn kernel such as gluten, any residual unreacted starch, solubles such as proteins and enzymes, and the byproducts and residue of fermentation including dead yeast cells. The particle sizes range widely from broken parts of kernels 1-2 millimeters in size, down to fines in the under 10 micron range. Typically, stillage is dewatered to produce animal feeds rich in protein. This feed-production process has added benefit of reducing waste disposal costs from the alcohol production. It also has the very important benefit of providing a rich protein source to cattle not derived from reprocessed cattle carcasses (an important concern for transmission of damaging prions).

A conventional process for handling stillage, currently used in typical dry mill ethanol plants has aqueous solids, such as whole stillage from corn, flow from a distillation column to a solid bowl decanter centrifuge which separates the feed stream according to density into cake (the “heavier” substances), and thin stillage (the lighter substances). Since most corn solids are heavier than water, the cake contains most of the solids. The thin stillage typically has 7 to 9% (up to 15% solids in some cases) of which about 10% or more are suspended insoluble solids, the remainder being dissolved solids including proteins, acids, unreacted sugars, and others. The suspended solids in the thin stillage are predominately fines but there is not a sharp cutoff since some larger particles are subject to carry-over with the liquid leaving the decanter centrifuge. Thin stillage is typically accumulated in a holding tank, from which 20-60% (typically 20 to 40%) is recirculated as “backset” to the cooking and fermentation stages to provide nutrients and to reduce the fresh water requirements. The remainder of the thin stillage is sent to the evaporator which concentrates the solids to a syrup of typically 30-35% solids in dry mill plants. Wet mill plants, which do not have such a load of insoluble solids, can achieve a syrup concentration of 50%. This syrup is added to the cake and the combined stream is, typically, sent to the dryer (not shown) to be dried to about 10-11% moisture.

The dewatering machinery which are generally most effective at producing high dry solids content, such as screen centrifuges and screw presses, have not proven feasible with corn stillage. Indeed, corn stillage and stillage from other grain fermentation has proven to be too fine and sticky for most separation devices. The typical industry practice has been to dewater such stillage using a solid bowl decanter centrifuge which is very functional, but which typically only produce cake solids content in the 30-35% range, in addition to having high electricity usage and high maintenance costs. However, up till now, the only way to improve performance of thin stillage evaporation has been to accomplish the most complete centrifugation of the stillage.

Numerous methods of overcoming this situation have been reported, such as separating most of the solids from the beer liquid prior to distillation so as to permit use of a screw press as described by B. J. Low in “The Efficient Production of High Quality Distiller's Dark Grains Using Stored Dehydration Process Technology.” The separation step is followed by dewatering in a screw press to a solids content of 50-54%, and then by drying in a special dryer. However, the presence of the alcohol at the separation step greatly complicates the drying process, requiring special closed-cycle dryers which are costly to purchase and expensive to maintain, as well as necessitating an alcohol vapor recovery system.

In some such ethanol production processes, such as in the production of ethanol from citrus residue as described in U.S. Pat. No. 4,952,504 issued to Pavilon, highly effective dewatering machinery such as screen centrifuges and screw presses (yielding dry-solids content typically 35-50% or higher) can be used to efficiently dewater solids filtered from the wort prior to fermentation. In fermentation from grains such as corn, however, this dewatering from the wort stage has the disadvantage of reducing the final alcohol yield.

U.S. Pat. No. 4,552,775, issued to Baeling, discloses a method for dewatering the stillage from a unique fermentation process which produces stillage of 20-30% dry substance (compared to the conventional corn fermentation which produces a stillage in the 5-12% solids range). This high solids stillage is combined with sufficient recycled dry product to obtain a 50-70% dry substance content which is then pelletized before drying in a through air dryer of special design. This method has the disadvantage that when applied to conventional stillages of 5-12% solids, the required recycle rate becomes very large, increasing the size and expense of the dryer.

Moreover, the exhaust from dryers presently requires processing to remove volatile organic compounds (VOCs) and particulate entrainment to comply with present emission standards. These compounds can include acetic acid, partially oxidized oils (from corn oil), higher alcohols, and products of partial combustion/oxidation of proteins and other organic constituents of the concentrated syrup and centrifuged cake.

A significant need remains for an improved, efficient and cost-effective method and apparatus to dewater conventional grain stillage, for the fuel alcohol industry and better integrate the dryer into a more efficient overall process.

The production of gasohol by the blending of fuel grade ethanol with gasoline has the potential for helping meet energy needs. Alcohol blends with gasoline require 99.35 percent alcohol to prevent phase separation of residual water. To make effective use of ethanol as a substitute fuel the energy consumed to make the fuel grade alcohol must be less than the energy obtained from ethanol (84,090 Btu/gal or 7120 cal/g).

The conventional method to concentrate an aqueous solution of ethanol involves two steps: first, a dilute ethanol-water mixture (6-12 percent ethanol) is distilled to about 95 percent; next, the solution of step one is azeotropically distilled to anhydrous alcohol having a concentration of about 99.8 percent. Distillation energy requirements are composed of the steam required for the main distillation step producing azeotropic ethanol and that required for breaking the azeotrope and producing essentially anhydrous ethanol. The energy for the first step depends more on the feed ethanol concentration than any other factor and this energy represents the minimum practical energy usage for a plant. Simple (non-azeotropic) distillation is limited with regard to ethanol-enrichment because the alcohol-water mixture forms a constant boiling azeotrope at 95.6 percent ethanol. One complication at this upper end is an inflection in the vapor-liquid equilibrium relationship, which upon closer approach to the azeotropic composition requires a considerable increase in the number of distillation trays required and the height of the column. The energy required for azeotropic distillation is typically recovered for use in preheating and to offset heat requirements in the main distillation. An example of this is U.S. Pat. No. 4,422,903. This patent teaches the art of constructing a double effect stripping/rectification column and recovering heat from azeotropic distillation to one of the two stripping/rectification columns.

The theoretical amount of energy expended to distill ethanol from 5 to 100 percent calculated by balancing heat input into the system and heat lost is about 3420 cal/g. In industrial practice, the actual energy expended during distillation is lower than theoretical due to the inclusion of various heat recovery systems. The reported loss of the fuel value to distill from 10 percent to 95 percent ethanol in industrial practice is about 13-21 percent; the loss of fuel value to concentrate from 95 to 100 percent by azeotropic distillation with benzene is an additional 7-11 percent. Overall expenditure is about 1400-2400 cal/g. The capital cost to produce 100 percent ethanol with an expenditure of only about 1400 cal/g is nearly double that of a distillation plant producing 95 percent ethanol due to the inclusion of azeotropic distillation equipment and advanced design heat recovery systems.

Several alternate approaches to obtain anhydrous ethanol which eliminate the energy costly azeotropic distillation have been suggested. These include dehydrating ethanol with such materials as gypsum, calcium chloride and lime, molecular sieves, biomass materials or the like or solvent extraction. One technique involves the use of sorbents to selectively adsorb water from an ethanol-water mix. In the Purdue process (Chemical Engineering, Vol. 87, p. 103, Nov. 17, 1980), ethanol-rich vapors (80-92 percent ethanol) leaving a first stage distillation at a temperature of about 78 [deg]-80 [deg] C. are passed directly onto a column of cornmeal to adsorb water and obtain anhydrous ethanol. After the column is saturated, the cornmeal is regenerated by passing hot (90. degree.-120 [deg] C.) air over it; simultaneously, a second previously regenerated column is brought into operation. Overall energy expenditure for the distillation and sorption processes including the distillation step is about 1000 cal/g. The process is used in a modified fashion industrially in which corn grits and carbon dioxide are substituted for cornmeal and air.

The most accepted approach to dehydration now used industrially is to use type 3A Zeolyte molecular sieve adsorption. Typically a two bed system is used in which one bed receives a flow of azeotropic ethanol for dehydration and the other undergoes regeneration. The beds are operated in a vapor phase pressure swing approach. The dehydration takes place at an elevated pressure while the regeneration takes place under vacuum. Typically overhead azeotropic ethanol from distillation is condensed, pumped to a vaporizer to elevate the dehydration pressure then recondensed after dehydration. Under this process configuration the ethanol is condensed twice without recovery. Another industrially applied technique is to supply the azeotropic ethanol directly from the distillation column without first condensing and only condense after dehydration. In this case the ethanol is condensed once without recovery.

Thus a system that effectively reuses energy from the drying process and eliminates the need for additional processing of dryer exhaust would be desirable. Moreover, a system that effectively removes insoluble solids prior to evaporation, dewaters solids using waste heat, reduces the rate of fouling in distillation and on heating surfaces, and uses non-azeotropic methods of ethanol dehydration in which energy is further recovered to the process would be further desirable.

The present invention addresses these and other needs.

### SUMMARY OF THE INVENTION

The present invention is for the production of fuel grade alcohol, preferably ethanol. A steam dryer is used to dry the solid byproduct into usable animal feed. The steam dryer that typically contains less than 6% air in its exhaust stream is directed to the bottoms of one or more distillation columns to heat the distillation column and scrub the exhaust stream simultaneously. The elimination of the thermal oxidizer to clean the normal air exhaust from the dryer and the efficient use of the energy in the exhaust stream provide considerable cost savings for an alcohol production plant.

In one embodiment, there is an apparatus or system for producing distilled alcohol. The apparatus or system comprises an alcohol fermentor to produce an alcohol containing feed. The apparatus or system further comprises a first distillation column configured to receive the alcohol containing feed. The first distillation column is configured to produce a first overhead stream comprising alcohol and a first bottoms stream comprising stillage. The apparatus or system further comprises a steam dryer configured to dry solids from still bottoms and produce an exhaust vapor that contains less than 6% air, preferably less than 3% air. The exhaust vapor from the dryer is scrubbed by the first distillation column to condense the water in the exhaust vapor while simultaneously heating the distillation column.

In another embodiment, the present invention is an apparatus or system for distilling an alcohol containing feed. The system comprises a distillation column configured to receive an alcohol containing feed (typically beer feed) and a dryer exhaust stream from a dryer. The alcohol containing feed in the distillation column removes particulate matter from the dryer exhaust stream. The dryer exhaust provides heat to distill the beer feed into a first overhead stream containing alcohol and a first bottoms stream that contains water and fermentation solids.

In another embodiment the apparatus or system includes a second distillation column for further separating alcohol from water in the first overhead stream. The second distillation column produces a second overhead stream containing alcohol and a second bottoms stream containing water.

In still another embodiment, the apparatus or system set forth above further comprising one or more evaporators in thermal communication with one of the first overhead stream and second overhead stream. The one or more evaporators evaporate water from thin stillage into syrup.

The apparatus or system of one or more embodiments disclosed above optionally comprises one or more molecular sieve dehydration units in fluid communication with the first overhead stream. The one or more molecular sieve dehydration units are configured to remove sufficient water from the first overhead stream to produce fuel grade alcohol.

Optionally or additionally the apparatus or system further comprises one or more molecular sieve dehydration units in fluid communication with one of the first overhead stream and the second overhead stream. The one or more molecular sieve units are configured to remove sufficient water from the second overhead stream to produce fuel grade alcohol.

The apparatus or system of another embodiment utilizes a superheated steam dryer.

In still another embodiment, the steam dryer produces animal feed grade solids.

Preferably, the first distillation column eliminates the need for additional processing the dryer exhaust stream to meet current emissions standards in the apparatus or system of one or more embodiments of the present invention. In the preferred operation, the emissions are reduced to a fraction of what can be achieved by currently available technology.

The apparatus or system of one or more embodiments optionally uses a dryer exhaust stream that contains volatile organic compounds (VOCs) and particulate entrainment that requires treatment before emissions. These compounds can include acetic acid, partially oxidized oils (from corn oil), higher alcohols, and products of partial combustion/oxidation of proteins and other organic constituents of the concentrated syrup and centrifuged cake.

Optionally, the first overhead stream that is produced in one or more of the systems above contains a minimum of 90 wt. % alcohol.

The present invention further includes a process of heating an alcohol distillation column for distilling an alcohol containing stream comprising heating the distillation column with a dryer exhaust stream that contains less than 6% air to distill alcohol from the alcohol containing stream. The process advantageously scrubbing the drier exhaust vapor during the step of heating the distillation column.

The dryer exhaust vapor optionally contains less than 3% air. Additionally and optionally, the dryer exhaust contains particulates, acetic acid, partially oxidized oils (from corn oil), higher alcohols, and products of partial combustion/oxidation of proteins and other organic constituents of the concentrated syrup and centrifuged cake that require treatment.

The process of one or more embodiments of the present invention further produces a first overhead stream from the first distillation column that contains a minimum of 90 wt. % alcohol.

The process further comprises the optional use of the first overhead stream to one or more evaporators that is heated by condensing the first overhead stream.

In still another embodiment there is a process of cleaning and scrubbing the dryer exhaust vapor in an alcohol distillation plant. This process comprises the steps of providing a dryer exhaust that contains less than 6% air; and scrubbing the dryer exhaust in a beer stripper column, thereby eliminating the need for additional processing of the drier exhaust to satisfy environmental emissions controls and preferably to reduce emissions to levels below current mandates.

In another embodiment, there is the use of dryer exhaust vapor containing less than 6% air and preferably less than 3% air to supply heat and stripping vapor to the distillation column for stripping ethanol from the beer feed.

In yet another embodiment, there is a use of the stripping section of the ethanol distillation (beer column or stripping column) to clean and scrub the dryer exhaust vapor of any particulate and volatile organic emissions so as to eliminate the need of further environmental emissions controls and preferably to reduce emissions to levels below current mandates.

### BRIEF DESCRIPTION OF THE DRAWINGS

FIG. 1 is a schematic of a state of the art distillation process.

FIG. 2 is a schematic of a retrofit modification of the distillation process of FIG. 1 to include one or more aspects of the present invention.

FIG. 3 is a schematic of a distillation process according to one or more embodiments of the present invention.

### DETAILED DESCRIPTION OF THE EMBODIMENTS OF THE INVENTION

As noted, the present invention is for the production of alcohol, preferably ethanol. More preferably ethanol that is fuel grade. By fuel grade it is meant alcohol that has a sufficiently low water content to meet the current standards for use as a blend in ethanol blended gas or “gasohol.”

In the present invention, a steam dryer is used to dry the solid byproduct into usable animal feed. The steam dryer is indirectly superheated by a furnace so that the content of the steam dryer exhaust contains very low levels of external air. By external air it is meant the primary components of ambient air such as nitrogen, oxygen and carbon dioxide that will not condense under the process conditions of the alcohol plant. The steam dryer exhaust typically contains less than about 6 wt. %, preferably less than about 3 wt. % air. Other impurities such as volatile organic compounds (VOCs) and particulate entrainment are contained in the dryer exhaust. The balance is water in the form of steam.

The steam dryer (often referred to as a superheated steam dryer or an “airless” dryer) takes superheated steam and passes it through the material to be dried. In the present application the dryer receives a mixture of solid cake and syrup produced in the distillation process (which will hereinafter be referred to for simplicity as “solid cake.” The superheated steam heats the water in the solid cake and syrup to evaporate it and produce a dry product that can be easily stored and sold as a food source for animals. In the present invention, the portion of the steam that is removed from the steam dryer is the dryer exhaust. The dryer exhaust is sent to a distillation column (sometimes designated first distillation column).

A distillation column is defined as a column that has temperature at the top of the column that is lower than the bottom of the column and functions to separates a mixture of two liquids by vapor pressure. As used herein, the term “first” or “second” as it applies to various components or steps in the description is an arbitrary designation to distinguish one column from any other column and doesn't refer to a sequence of columns unless explicitly stated.

Preferably, the dryer exhaust is directed to a beer stripper column. The beer stripper column is the column into which the beer feed from the fermentation tank is fed. The beer feed contains ethanol, water, fermentation agent such as yeast, other volatile organic compounds that are produced during fermentation and solids that were present to provide a starch or sugar source during fermentation. Typically, the beer feed contains a minimum of about 6%, about 8%, or about 10% alcohol and a maximum of about 16%, about 14% or about 12% alcohol. The solid content is a minimum of about 10%, about 12% and generally less than 15 wt. % based upon the total weight of the beer feed. Apart from other volatile organic byproducts of the fermentation process, the remainder of the beer feed is water.

The dryer exhaust is preferably directed to the bottoms of the distillation column because it provides heat to the column. Typically, the beer feed is directed into the top of the column if the rectification section is designed as a separate distillation column from the beer stripping. The distillation column that receives the dryer exhaust functions synergistically to scrubs the solids and other components from the dryer exhaust that cannot be released into the environment and quenches the steam from the dryer exhaust into water.

Simultaneously, the heat from the dryer exhaust vapor evaporates the alcohol and produces the heat input that drives the distillation process. The condensed water from the dryer exhaust and other solid impurities are removed from the bottoms with the water and solids from the beer feed. Thus, a dedicated heat source using fossil fuel or other fuel to drive the distillation column is eliminated. The need for separate equipment to clean the dryer exhaust is likewise not needed. The elimination of the thermal oxidizer or other dryer exhaust air cleaning devices and the efficient use of the energy in the exhaust stream provide considerable cost savings for an alcohol production plant.

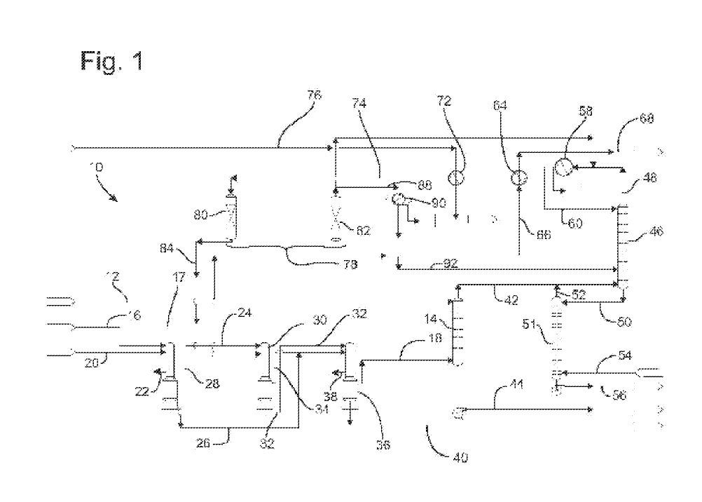

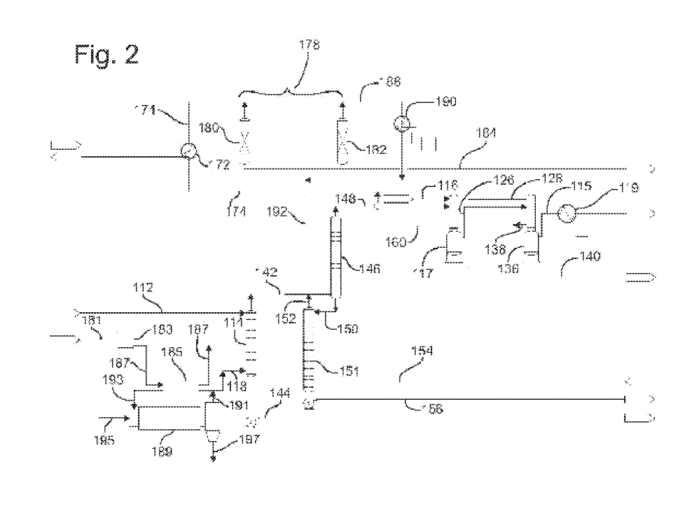

The present invention has been designed to be able to retrofit an existing plant or build a grass roots plant with this advantageous feature. The retrofit design of a plant is best illustrated with reference to FIG. 1 (a state of the art plant) and FIG. 2 (a retrofitted plant) to show the steps of retrofitting and the differences between a state of the art plant and a plant that has the features of the present invention.

FIG. 1 illustrates the relevant parts of an example of an existing ethanol plant. Further reference is made to U.S. Publication No. 2007/0000769 (Brown) which is incorporated by reference into this application in its entirety. As noted in FIG. 1, beer feed 12 is directed into the top of the beer stripper column 14 which is distilled with heated process steam 18 from heat supplied by primary steam 20 and fuel grade ethanol vapor (preferably 200 proof ethanol) 84 from the two “First Effect Evaporators.”

The thin stillage is the portion of still bottoms 44 after the solids in the still bottoms 44 is removed. The thin stillage passes along stream 16 enters a first effect evaporator 17 where it is undergoes a first stage of evaporation that is heated by process steam from stream 20. The process steam 20 is cooled to condensate and removed along stream 22. A portion of the thin stillage is evaporated and the evaporated water is removed along stream 26. The first concentrated portion of the thin stillage is removed as evaporator bottoms along conduit 28 to the First Effect Plus MSU Heat Recovery Evaporator for a second stage of evaporation. The “First Effect Plus MSU Heat Recovery Evaporation” unit 30 is heated by dehydrated ethanol from the dehydrating bed 80 of the molecular sieve unit 78 along stream 84. The alcohol from stream 84 is condensed and withdrawn along stream 66 to a final stage of cooling before it becomes fuel grade alcohol product, preferably 200 proof fuel alcohol product.

The process steam produced in evaporator 30 is withdrawn along conduit 34 where it is combined with steam in conduit 26 from evaporator 17 and passes into the second effect evaporator 36 for a third stage of evaporation. The concentrated stillage from evaporator 30 is withdrawn along conduit 32 where it enters the second effect evaporator 36 and evaporated by process steam from evaporators 17 and 30. The steam condensed from combined streams 26 and 34 are condensed to produced process condensate. The process condensate is withdrawn along stream 38 can be use anywhere process water is required in the plant. The steam produced by the second effect evaporator 36 passes to the bottoms of the beer stripper column 14 along stream 18 where it provides heat to operate the beer stripper column 14. The evaporated stillage (now called syrup) is withdrawn from the third stage of evaporation along stream 40.

The bottoms of the beer stripper column 14 is operated at a temperature that is a maximum of about 192 F, and a minimum of about 180 F, but preferably about 185 F. The overhead of the beer stripper column 14 is operated at a temperature that is a maximum of about 165 F, and a minimum of about 150 F, but preferably about 158 F. The beer stripper column 14 operates at a pressure that is a minimum of about 7.5 psia, a maximum of about 10 psia and preferably 8.38 psia. The overhead to the beer stripper column 14 contains a minimum of 50 wt. % and a maximum of 58 wt. % ethanol. Still bottoms are withdrawn from the beer stripper column along stream 44. The still bottoms in stream 44 contain all of the solids in the beer feed and water. The bottoms of the beer stripper column 14 contains a minimum of about 11 wt. % solids and a maximum of about 16 wt. % solids. The still bottoms are processed according to techniques known in the art to produce thin stillage, process water and dried solid cake which is used as feed for animals.

The overhead stream 42 from the beer stripper column 14 of the embodiment of FIG. 1 is directed into the bottoms of a rectifying column 46. The rectifying column 46 is heated by the overhead vapors of the beer stripping column 14 through conduit 42 and by the overhead vapors of auxiliary column 51 through conduit 52. Condensate from the regeneration of the molecular sieve system 78 (regenerating bed 82) is returned through conduit 92 for recovery of ethanol from that stream.

The bottom stream 50 of the rectifying column 46 is operated at a temperature that is a maximum of about 165 F, and a minimum of about 150 F, but preferably about 157 F. The overhead stream 48 of the rectifying column is operated at a temperature that is a maximum of about 140 F, and a minimum of about 128 F, but preferably about 132 F. The rectifying column 46 operates at an overhead pressure that is a minimum of about 4.8 psia, and a maximum of about 6 psia, but preferably about 5.7 psia. The composition of the overhead stream 48 of the rectifying column 46 is a minimum of about 90 wt. % and a maximum of 95 wt. % ethanol. The temperature of the overhead stream 48 of the rectifying column 46 is controlled by a condenser loop identified by streams 48 and 60 and heat exchanger 58 which cools the overhead stream 48 to the desired temperature along with control of pressure and composition at the top of the rectifying column 46. The final removal of water from the rectifier overhead stream 48 occurs in the molecular sieve unit 78 which will be discussed hereinafter.

The bottoms of the rectifying column 46 are withdrawn along line 50 into an optional auxiliary column 51. The auxiliary column separates any ethanol that is in the bottoms of the rectifying column to remove water. The rectifying column is heated by flash steam from the mash cooking and processing at the front end of the plant and this t enters the auxiliary column along stream 54. The advantage of the use of an auxiliary column 51 is that it can be operated free of the solids that are present in the beer stripper column 14. Thus the bottom stream 56 of the auxiliary column 51 produces relatively clean process water that can be used anywhere process water is required in the ethanol distillation plant or further processed as wastewater. The bottom stream 54 of the auxiliary column is operated at a temperature that is a maximum of about 188 F, and a minimum of about 178 F, but preferably about 183 F. The overhead of the auxiliary column is operated at a temperature that is a maximum of about 170 F, and a minimum of about 160 F, but preferably about 164 F. The auxiliary column operates at a pressure that is a minimum of about 7.5 to 8.0 psia, a maximum of about 8.5 to 10 psia and preferably 8.38 psia. The composition of the overhead of the auxiliary column is a minimum of about 30 wt. % and a maximum of 45 wt. % ethanol.

As noted above, the overhead stream 48 of the rectifying column passes along streams 48 and 74 through preheater 64 where it is pre-heated by fuel grade ethanol. Then, it continues along stream 74 where it is heated by a process steam 76 in heat exchanger 72 until it is fully vaporized. In its vaporized condition, the ethanol stream 74 undergoes further removal of water by the molecular sieve unit 78, preferably a pressure swing absorption molecular sieve unit. Stream 74 is directed to the dehydrating bed 80. The remaining water is removed in the dehydrating bed of the molecular sieve unit to produce fuel grade ethanol vapor. The fuel grade ethanol vapor is removed along stream 84 where it is used in part in evaporator 32, transferred along streams 66 where it is further cooled in heat exchanger 64 to produce a final product stream of fuel grade ethanol in stream 68.

Referring now to FIG. 2, illustrating a retrofit of a plant of FIG. 1 with the present invention. As noted in FIG. 2, beer feed 112 is directed into the top of the beer stripper column 114 which is distilled with heated steam from the exhaust stream 118 a steam dryer 189, preferably a superheated steam dryer which directly enters the bottoms of the beer stripper column 114. The exhaust stream contains water, less than 6 wt. % air (preferably 3 wt. % air) based upon the composition of the exhaust stream and particulates and other organic matter that requires removal before the exhaust stream can be disposed.

Typically, the exhaust stream 118 would be cleaned in a separate thermal oxidizer (not shown) requiring a significant capital expenditure for the equipment and significant operating expense. The heat from the exhaust stream 118 would not be reused in the process, but simple be exhausted to atmosphere after cleaning. Particularly, it would not be directly used by returning the exhaust stream directly to the product process flow. However, by so doing, the capital expenditure for an additional cleaning system (and other equipment can be avoided) and the heat can be recovered and used effectively.

In the present invention, the beer feed 112 scrubs the exhaust stream 118, quenches the water in the stream, and removes impurities such as volatile organic compounds (VOCs) and particulate entrainment. The solid impurities are removed from the bottom stream 156 of the stripper column.

The steam dryer is fueled by a fuel source represented by 181 which is burned in a furnace to heat a fuel exhaust stream 187. The fuel source may be natural gas, propane, kerosene or any other solid fuel source. In one preferred embodiment, the fuel is solid biomass that is unsuitable for use in the fermentation process such as corn stalks and corn husks.

The furnace 183 produces a fuel exhaust stream 187 which is passed through heat exchanger 185 to heat (or superheat) steam from stream 191 to produce superheated steam in stream 193 for use in the dryer 189. Thereafter the cooled fuel exhaust stream 187 is passed to the dryer system vent after heat exchanger 185.

The steam cycle represented by streams 191 and 193 are continuously heated and recycled and fed into dryer 189. Wet solids and syrup is fed into the dryer along 195 where the superheated steam from stream 193 passes in a direct heat exchange relationship with the wet solids and syrup. The water in the wet solids and syrup is vaporized and is removed from the wet solids and syrup, thereby drying the wet solids and syrup into a usable dry form. This usable dry form is removed as shown by direction arrow 197. The solids can be pelletized, dried into a powder or granule as desired.

The steam from the dryer is recovered from the dryer 189 and in part recycled through the heat exchanger 185 along the loop represented by streams 191 and 193. A portion of the steam is withdrawn along 118 as dryer exhaust. The exhaust steam in stream 118 is desuperheated by a spray of water to reduce the temperature to close to its dew point. The temperature of the exhaust stream as it enters the beer stripper column 114 is a minimum of about 203 F, maximum of about 220 F and preferably about 209 F.

The steam produced by dryer 189 passes to the bottoms of the beer stripper column 114 along stream 118 where it provides heat to operate the beer stripper column 114. The bottoms of the beer stripper column 114 is operated at a temperature that is a maximum of about 218 F, a minimum of about 203 F and preferably about 209 F. The overhead of the beer stripper column 114 is operated at a temperature that is a maximum of about 185 F, a minimum of about 173 F and preferably about 176 F. The beer stripper column 114 operates at a pressure that is a minimum of about 13 psia, a maximum of about 18 psia and preferably 14.8 psia. The overhead to the beer stripper column 114 contains a minimum of 50 wt. % and a maximum of 58 wt. % ethanol. Still bottoms are withdrawn from the beer stripper column along stream 156. The still bottoms in stream 156 contain all of the solids in the beer feed and water. The bottoms of the beer stripper column 114 contains a minimum of about 11 wt. % solids and a maximum of about 16 wt. % solids. The still bottoms are processed according to techniques known in the art to produce thin stillage, process water and dried solid cake which is used as feed for animals.

The overhead stream 142 from the beer stripper column 114 of the embodiment of FIG. 2 is directed into the bottoms of a rectifying column 146. The rectifying column 146 is also heated by overhead of the beer stripper column 114 and the auxiliary column. The bottom stream 150 of the rectifying column 146 is operated at a temperature that is a maximum of about 185 F, a minimum of about 173 F and preferably about 176 F. The overhead stream 148 of the rectifying column 146 is operated at a temperature that is a maximum of about 165 F, a minimum of about 150 F and preferably about 160 F. The rectifying column 146 operates at a pressure that is a minimum of about 11 psia, a maximum of about 14 psia and preferably about 12 psia. The composition of the overhead stream 148 of the rectifying column 146 is a minimum of about 90.0 wt. % and a maximum of 95.0 wt. % ethanol.

The temperature of the overhead stream 148 of the rectifying column 146 is controlled by a first effect evaporator 117. Thin stillage passes along stream 116 enters the first effect evaporator 117 where it is undergoes a first stage of evaporation that is heated by overhead stream 148 thereby condensing and cooling the overhead stream 148. A portion of the thin stillage is evaporated and the evaporated water is removed along stream 126. The concentrated portion of the thin stillage is removed as evaporator bottoms along conduit 128 to the second effect evaporator 136 for a second stage of evaporation. The steam from stream 126 is condensed to produce process condensate while evaporating the concentrated stillage in evaporator 136. The process condensate is withdrawn along stream 138 can be use anywhere process water is required in the plant. The evaporated steam is withdrawn along 115 where it can be used for additional heat recovery. Optionally, it can be used in heat exchanger 119. Another option is that the fuel grade ethanol (preferably 200 proof) vapor that was used to provide heat for the eliminated evaporator of FIG. 1 can be used for efficient heat recovery elsewhere where it is needed or the evaporator using the fuel grade alcohol vapor (preferably 2000 proof) can be incorporated into the retrofitted plant for additional evaporation. In many cases, additional evaporation equipment, optionally, is used to satisfy the total load of thin stillage to be concentrated or to allow concentration to higher solids levels (i.e.: 40 to 45 wt. %). In another implementation of this invention, the order that the evaporators encounter the thin stillage can be changed. For example, the thin stillage can be feed first to a second effect evaporator or a third effect evaporator before the first effect evaporator and syrup is withdrawn from the first effect evaporator. Any order of liquid feed sequence can be used and still maintain the heat integration proposed.

The bottoms of the rectifying column 146 are withdrawn along line 150 into an optional auxiliary column 151. The auxiliary column 151 separates any ethanol that is in the bottoms of the rectifying column 146 to remove water. The rectifying column 146 is heated by flash steam from the mash cooking and processing at the front end of the plant and this enters the auxiliary column along stream 154. Alternately dryer exhaust vapor can be used to heat the auxiliary column. The advantage of the use of an auxiliary column 151 is that it can be operated free of the large amount of solids that are present in the beer stripper column 114. Thus the bottom stream 156 of the auxiliary column 151 produces relatively clean process water that can be used anywhere process water is required in the ethanol distillation plant or further processed as wastewater. The bottom stream 154 of the auxiliary column is operated at a temperature that is a maximum of about 215 F, about a minimum of 203 F and preferably about 209 F. The overhead of the auxiliary column is operated at a temperature that is a maximum of about 195 F, about a minimum of 168 F and preferably about 180 F. The auxiliary column operates at a pressure that is a minimum of about 13 psia, a maximum of about 18 psia and preferably 14.8 psia. The composition of the overhead of the auxiliary column is a minimum of about 30 wt. % and a maximum of 45 wt. % ethanol.

The overhead stream 148 of the rectifying column is condensed in evaporator 117. The condensate from the evaporator 117 passes along stream 160 which is split for reflux to the rectifying column 146 and a feed stream 174. The feed stream 174 is sent to a molecular sieve unit vaporizer 172 where it is heated by steam until it is fully vaporized and superheated. In its vaporized condition, the ethanol stream 174 undergoes further removal of water by the molecular sieve unit 178, preferably a pressure swing absorption molecular sieve unit. Stream 174 is directed to the dehydrating bed 180. The remaining water is removed in the dehydrating bed of the molecular sieve unit to produce fuel grade ethanol vapor. The fuel grade ethanol vapor is removed along stream 184 where it is available for additional heat recovery and further operational cost savings and finally to produce a final product stream of fuel grade ethanol.

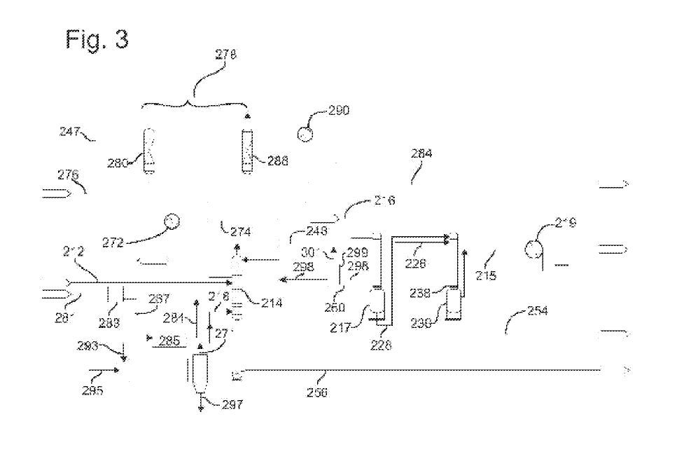

Referring now to FIG. 3, illustrating a grass roots design of a plant one embodiment of the present invention. The grassroots plant has the potential of greater savings because it is not designed to use as much of the preexisting hardware and the new equipment can be optimized to fully use the heat available from the dryer.

As noted in FIG. 3, beer feed 212 is directed into the middle of the combined beer stripper column and rectifier column 214 (hereinafter referred to as the beer distillation column 214) which is distilled with heated steam from the exhaust stream 218 by a steam dryer 289, preferably a superheated steam dryer which directly enters the bottoms of the beer distillation column 214. The exhaust stream contains water, less than 6 wt. % air (preferably 3 wt. % air) based upon the composition of the exhaust stream and particulates and other organic matter that requires removal before the exhaust stream can be disposed.

Typically, the exhaust stream 218 would be cleaned in a separate thermal oxidizer (not shown) requiring a significant capital expenditure for the equipment. The heat from the exhaust stream 218 would not be reused in the process, but simply be exhausted to atmosphere after cleaning. Particularly, it would not be directly used by returning the exhaust stream directly to the product process flow. However, by so doing, the capital expenditure for additional cleaning equipment (and other equipment can be avoided) and the heat can be recovered and used effectively.

In the present invention, the beer feed 212 scrubs the exhaust stream 218, quenches the water in the stream, and removes impurities such as volatile organic compounds (VOCs) and particulate entrainment. The solid impurities are removed from the bottom stream 256 of the beer stripper column 214.

The steam dryer is fueled by a fuel source represented by 281 which is burned in a furnace to heat a fuel exhaust stream 287. The fuel source may be natural gas, propane, kerosene or any other solid fuel source. In one preferred embodiment, the fuel is solid biomass that is unsuitable for use in the fermentation process such as corn stalks and corn husks.

The furnace 283 produces a fuel exhaust stream 287 which is passed through heat exchanger 285 to heat (or superheat) steam from stream 291 to produce superheated steam in stream 293 for use in the dryer 289. Thereafter, the cooled fuel exhaust stream 287 is passed to the dryer system vent after heat exchanger 285.

The steam cycle represented by streams 291 and 293 are continuously heated and recycled and fed into dryer 289. Wet solids and syrup is fed into the dryer along 295 where the superheated steam from stream 293 passes in a direct heat exchange relationship with the wet solids and syrup. The water in the wet solids and syrup is vaporized and is removed from the wet solids and syrup, thereby drying the wet solids and syrup into a usable dry form. This usable dry form is removed as shown by direction arrow 297. The solids can be pelletized, dried into a powder or granule as desired.

The steam from the dryer is recovered from the dryer 289 and in part recycled through the heat exchanger 185 along the loop represented by streams 291 and 293. A portion of the steam is withdrawn along 218 as dryer exhaust. The exhaust steam in stream 218 is desuperheated by a spray of water to reduce the temperature to close to its dew point. The temperature of the exhaust stream as it enters the beer distillation column 214 before it enters the beer distillation column is a minimum of about 203 F, maximum of about 220 F and preferably about 209 F.

The steam produced by dryer 289 passes to the bottoms of the beer distillation column 214 along stream 218 where it provides heat to operate the beer distillation column 214. The bottoms of the beer distillation column 214 are operated at a temperature that is a maximum of about 218 F, a minimum of about 203 F and preferably about 209 F. The overhead stream 248 of the beer distillation column 214 is operated at a temperature that is a maximum of about 165 F, a minimum of about 150 F and preferably about 160 F. The beer distillation column 214 operates at a pressure that is a minimum of about 13 psia, a maximum of about 18 psia and preferably 14.8 psia. The overhead to the beer distillation column 214 contains a minimum of 90 wt. % and a maximum of 95 wt. % ethanol. Still bottoms are withdrawn from the beer distillation column along stream 256. The still bottoms in stream 256 contain all of the solids in the beer feed and water. The bottoms of the beer distillation column 214 contains a minimum of about 11 wt. % solids and a maximum of about 16 wt. % solids. The still bottoms are processed according to techniques known in the art to produce thin stillage, process water and dried solid cake which is used as feed for animals.

The temperature of the overhead stream 248 of the beer distillation column 214 is controlled by the first effect evaporator 217. The overhead stream 248 provides evaporative heat to the first effect evaporator 217. Thin stillage 216 passes along stream 216 enters a first effect evaporator 217 where it is undergoes a first stage of evaporation that is heated by overhead stream 248 thereby condensing and cooling the overhead stream 248. A portion of the thin stillage from stream 116 is evaporated and the evaporated water is removed along stream 226. The concentrated portion of the thin stillage is removed as evaporator bottoms along conduit 228 to the second effect evaporator 236 for a second stage of evaporation. The steam from stream 226 is condensed to produce process condensate while evaporating the concentrated stillage in evaporator 236. The process condensate is withdrawn along stream 238 can be use anywhere process water is required in the plant. The evaporated steam is withdrawn along 215 where it can be used for additional heat recovery. Optionally, it can be used in heat exchanger 219. The grass roots design of FIG. 3 likewise eliminates a third evaporator and has available the fuel grade ethanol (preferably 200 proof) vapor that was used to provide heat for the eliminated evaporator of FIG. 1 can be used for efficient heat recovery elsewhere where it is needed or an evaporator using the fuel grade ethanol vapor (preferably 200 proof vapor) can be incorporated into the plant for additional evaporation. In many cases the thin stillage can be processed to allow concentration to higher solids levels (i.e.: 40 to 45 wt. %). In another implementation of this invention, the thin stillage can be feed to the second or a third effect and syrup withdrawn from the first effect. Any order of liquid feed sequence can be used and still maintain the heat integration proposed.

The overhead stream 148 of the beer distillation column passes along streams 248, is condensed in evaporator 217, that condensate passes along stream 260 which is split for reflux to the distillation column 214 and a feed stream 274 sent to the molecular sieve unit vaporizer 280. Alternatively and optionally, the condensate is withdrawn from the first effect evaporator 217 along stream 298 where it is further condensed in a vented condenser 299. The vented condenser provides a vent outlet 301 to remove air that enters the process in the dryer exhaust 218.

The feed stream 274 is heated by steam from stream 276 in heat exchanger 272 until it is fully vaporized and superheated. In its vaporized condition, the ethanol stream 274 undergoes further removal of water by the molecular sieve unit 278, preferably a pressure swing absorption molecular sieve unit. Stream 274 is directed to the dehydrating bed 280. The remaining water is removed in the dehydrating bed of the molecular sieve unit to produce fuel grade ethanol vapor. The fuel grade ethanol vapor is removed along stream 284 where it is available for additional heat recovery and further operational cost savings and finally to produce a final product stream of fuel grade ethanol. Perhaps the most obvious savings in equipment is the replacement of the beer stripper column, auxiliary column and rectifier column with a single combined beer stripper and rectifier column. This presents an additional capital cost saving and energy savings as the cook flash is no longer needed to operate the auxiliary column and can be used elsewhere in the alcohol distillation plant to provide efficient heat use.

### EXAMPLE

A first fuel grade ethanol plant was constructed according to the schematic of FIG. 1 and designated, “Control Plant.” A second fuel grade ethanol plant was constructed according to U.S Publication No. 2007/0000769 (Brown) which discloses an ethanol distillation with distiller's soluble solids recovery apparatus providing energy economy superior to the typically constructed plant (“Control Plant”). A third fuel grade ethanol plant was constructed according to the schematic of FIG. 2 or 3 and designated, “Dryer Integration Plant.” Simulations were performed on the three designs based on a 55 MMGPY capacity with beer feed at 12 wt % ethanol, 11.95% total solids. Each plant had a beer feed rate of 338,000 lb/hr. The evaporators for all cases were assumed to produce 35% total solids syrup.

All cases assume that the centrifuges can recover 85% of the suspended solids with a 65% moisture cake and that 40% of the thin stillage is returned to fermentation as backset. Superheated steam dryers were assumed to be used in the Study Retrofit Plant and the Study Grassroots Plant. However, a normal hot air dryer was assumed to be used in the Control Plant although not specifically shown in FIG. 1. The dryer exhaust in each system is calculated to be 60,000 lb/hr of water vapor, based upon the assumption that the volume of solids produced by each plant would be consistent. It was further assumed that the cost of steam production would be $10.00 per 1000 pounds of steam produced. Savings reported in this study are based on an assumed 5% energy loss compared to the raw calculated steam usage.

The results of the study are shown below in Table 1:

TABLE 1
Operational Cost Analysis of Three Fuel Grade Ethanol Plants

| | | US Pub# | Dryer |
|---|---|---|---|
| | State of the | 2007/0000769 | Integration |
| System: | Art Plant | (Brown) | Plant |
| Raw Calculated Steam | 74,300 | 62,500 | 30,000 |
| (lb/hr): | | | |
| Normal Guarantee Steam | 81,700 | 68,750 | 33,000 |
| (lb/hr): | | | |
| Guarantee Steam/Denat. | 12.5 lb/gal | 10.5 lb/gal | 5 lb/gal |
| EtOH: | | | |
| Guarantee Btu/Denat. | 11,900 | 9,200 | 4,400 |
| EtOH: | | | |
| Approximate Yrly Saved: | 0 | $1,000,000 | $3,900,000 |

In addition to the savings illustrated in the above study are capital cost savings of building a grassroots plant that supplies a single beer column/rectifier column that eliminates the need for a separate rectifying column and eliminates entirely the auxiliary column. The elimination of a thermal oxidizer will also reduce overall capital costs for a grassroots plant and the operating cost of the oxidizer for both the grassroots and the retrofit plant.

If a plant is to be retrofitted to use the dryer exhaust from a superheated steam dryer exhaust integrated process, the cost of the retrofit is reduced by being able to use some of the existing equipment to reduce the cost of the facility. A few examples include the molecular sieve unit operation and the three distillation columns. Since this process uses a higher pressure in the columns, some increase in capacity of the plant could also be realized in a retrofit plant that is not reflected in the savings of Table 1 above. It is expected this increase would be in the range of 35% increase in capacity. This means that a 45 MMGPY plant could be retrofitted to increase capacity to 60 MMGPY. At $2.5/gallon that would be an additional $37.5 mM/year in gross revenue over an existing plant.

Accordingly, the use of (1) a superheated steam dryer to dry syrup and wet solids into dry solids for animal feed and (2) the use of the beer stripper to strip the dryer exhaust while simultaneously providing the heat needed to run the beer stripper column will result in significant operational savings, while expanding capacity by approximately 50% compared to a plant of comparable size and eliminate a significant amount of hardware resulting in lower costs of construction.

What is claimed is:

1. A system for producing distilled alcohol comprising:
an alcohol fermentor to produce an alcohol containing feed;
a first distillation column configured to receive the alcohol containing feed, the first distillation column is configured to produce a first overhead stream comprising alcohol and a first bottoms stream comprising stillage;
a steam dryer configured to dry solid from still bottoms and produce an exhaust vapor that contains less than 6% air, wherein the exhaust vapor from the dryer is scrubbed by the first distillation column to condense the water in the exhaust vapor while simultaneously heating the distillation column.

2. The system of claim 1, further comprising a second distillation column for further separating alcohol from water in the first overhead stream, the second distillation column produces a second overhead stream containing alcohol and a bottoms stream containing water.

3. The system of claim 1, further comprising one or more evaporators in thermal communication with one of the first overhead stream, the one or more evaporators evaporate water from thin stillage into syrup.

4. The system of claim 1, further comprising one or more molecular sieve dehydration units, in fluid communication with the first overhead stream, wherein the one or more molecular sieve dehydration units are configured to remove sufficient water from the first overhead stream to produce fuel grade alcohol.

5. The system of claim 2, further comprising one or more molecular sieve dehydration units in fluid communication with the second overhead stream, wherein the one or more molecular sieve units are configured to remove sufficient water from the second overhead stream to produce fuel grade alcohol.

6. The system of claim 1, wherein the steam dryer is a superheated steam dryer.

7. The system of claim 1, wherein the first distillation column eliminates the need for additional processing the dryer exhaust stream to meet current emissions standards.

8. A system for distilling an alcohol containing feed comprising:
a distillation column configured to receive an alcohol containing feed and a dryer exhaust stream from a dryer, wherein the alcohol containing feed removes particulate matter from the dryer exhaust stream and the dryer exhaust provides heat to distill the beer feed into a first overhead stream containing alcohol and a bottoms stream that contains water and fermentation solids.

9. The system of claim 8, wherein the dryer produces an exhaust that contains less than 6% air.

10. The system of claim 8, wherein the dryer exhaust stream contains volatile organic compounds (VOCs) and particulate entrainment that requires treatment before emissions.

11. The system of claim 8, wherein the first overhead stream contains a minimum of 90 wt. % alcohol.

12. The system of claim 8, further comprising one or more evaporators that are heated by the first overhead stream.

13. The system of claim 8, further comprising a rectifying column in fluid communication with the first overhead stream of the distillation column, the rectifying column further separates alcohol from water.

14. A process of heating an alcohol distillation column for distilling an alcohol containing stream comprising:
heating alcohol containing feed in the distillation column with a dryer exhaust stream that contains less than 6% air to distill alcohol from the alcohol containing stream.

15. The process of claim 14, further comprising simultaneously scrubbing the drier exhaust vapor during the step of heating the distillation column.

16. The process of claim 14 wherein the dryer exhaust vapor contains volatile organic compounds (VOCs) and particulate entrainment that requires treatment before emissions.

17. The process of claim 14, wherein the distillation column produces a first overhead stream that contains a minimum of 90 wt. % alcohol.

18. A process of cleaning and scrubbing the dryer exhaust vapor in an alcohol distillation plant, comprising:
providing a dryer exhaust that contains less than 6% air;
scrubbing the dryer exhaust with the alcohol feed in a beer stripper column, thereby eliminating the need for additional processing of the drier exhaust to satisfy environmental emissions controls.

19. The process of claim 18, wherein the dryer exhaust vapor contains less than 3% air.

20. The process of claim 18, wherein the dryer exhaust vapor contains volatile organic compounds (VOCs) and particulate entrainment that requires treatment before emissions.
